(19) United States
(12) Patent Application Publication
(10) Pub. No.: US 2011/0242130 A1
(43) Pub. Date: Oct. 6, 2011

(54) IMAGE PROCESSING APPARATUS, IMAGE PROCESSING METHOD, AND COMPUTER-READABLE MEDIUM

(75) Inventor: Kensuke TOBA, Iruma-shi (JP)

(73) Assignee: CASIO COMPUTER CO., LTD., Tokyo (JP)

(21) Appl. No.: 13/075,201

(22) Filed: Mar. 30, 2011

(30) Foreign Application Priority Data
Mar. 30, 2010 (JP) 2010-079299

(51) Int. Cl. G09G 5/00

(52) U.S. Cl. 345/629

(57) ABSTRACT

There is provided an image processing apparatus including a display unit, a memory that stores a plurality of images, and a processor. The processor performs a composite image production process of producing a composite image composed of a plurality of images stored in the memory, a composite image display process of displaying the produced composite image on the display unit, a region setting process of setting a clipping region on the displayed composite image, and an image clipping process of clipping an image in the same region as the set clipping region from each of the images before the composite image is produced and storing the clipped images in a memory.

### CROSS-REFERENCE TO RELATED APPLICATIONS

This application is based upon and claims the benefit of priority from prior Japanese Patent Application No. 2010-079299, filed Mar. 30, 2010, the entire contents of which are incorporated herein by reference.

### BACKGROUND OF THE INVENTION

1. Field of the Invention

The present invention relates to an image processing apparatus, an image processing method, and a computer-readable medium, capable of producing an object image used to analyze images from the images, such as consecutive images.

2. Description of the Related Art

Previously, for example, when the trajectory of motion of a body was analyzed mathematically on the basis of consecutive images including a moving body, the user had to clip an analysis object region from each of the consecutive images, while specifying a position of the same region image by image.

Not only a common background image but also images of a moving body were extracted from the consecutive images clipped as a region in the same position and each of the images of the moving body was superimposed on the background image to produce a composite image. In this connection, an image composition system which enables the trajectory of motion of a subject, the transition of motion form, or the like to be grasped easily with the help of such a composite image have been considered as disclosed in, for example, Jpn. Pat. Appln. KOKAI Publication No, 2006-005452.

To clip a region in the same position out of each of the consecutive images, the user had to specify a region in the same position image by image and clip the region, resulting in a very troublesome, inefficient work.

### BRIEF SUMMARY OF THE INVENTION

Accordingly, it is an object of the invention to provide an image processing apparatus, an image processing method, and a computer-readable medium, which make it unnecessary to specify a region image by image when clipping the region in the same position out of each of the consecutive images and enable the regions to be clipped en bloc.

According to a first aspect of the present invention, there is provided an image processing apparatus comprising: a display unit; a memory that stores a plurality of images; and a processor that performs: a composite image production process of producing a composite image composed of a plurality of images stored in the memory, a composite image display process of displaying the produced composite image on the display unit, a region setting process of setting a clipping region on the displayed composite image, and an image clipping process of clipping an image in the same region as the set clipping region from each of the images before the composite image is produced and storing the clipped images in a memory.

According to a second aspect of the present invention, there is provided an image processing apparatus comprising: a memory that stores a plurality of images; and a processor that performs: a moving point extraction process of extracting moving points in an image on the basis of each image stored in the memory, an approximate curve calculation process of calculating an approximate curve corresponding to the moving points extracted by the moving point extraction process, an object determination process of determining whether there is any object on the approximate curve in the images stored in the memory, and a region setting process of, when the object determination process has determined that there is an object, setting a clipping region that includes the moving points extracted by the moving point extraction process and the object and, when the object determination process has determined that there is no object, setting a clipping region that includes the moving points extracted by the moving point extraction process.

According to a third aspect of the present invention, there is provided a computer-readable medium that stores a program including a series of instructions executed by a computer system equipped with a display unit and a memory that stores a plurality of images, the program causing the computer system to perform: a composite image production process of producing a composite image composed of a plurality images stored in the memory, a composite image display process of displaying the produced composite image on the display unit, a region setting process of setting a clipping region on the displayed composite image, and an image clipping process of clipping an image in the same region as the clipping region set by the region setting process from each of the images before the composite image is produced and storing the clipped images in a memory.

According to a fourth aspect of the present invention, there is provided a computer-readable medium that stores a program including a series of instructions executed by a computer system equipped with a memory that stores a plurality of images, the program causing the computer system to perform: a moving point extraction process of extracting moving points in an image on the basis of each image stored in the memory; an approximate curve calculation process of calculating an approximate curve corresponding to the moving points extracted by the moving point extraction process; an object determination process of determining whether there is any object on the approximate curve in the images stored in the memory; and a region setting process of, when the object determination process has determined that there is an object, setting a clipping region that includes the moving points extracted by the moving point extraction process and the object and, when the object determination process has determined that there is no object, setting a clipping region that includes the moving points extracted by the moving point extraction process.

According to a fifth aspect of the present invention, there is provided an image processing method for use in a computer equipped with a display unit and a memory that stores a plurality of images, the method comprising: executing a composite image production process of producing a composite image composed of a plurality of images stored in the memory; executing a composite image display process of displaying the composite image produced by the composite image production process on the display unit; executing a region setting process of setting a clipping region on the composite image displayed in the composite image display process; and executing an image clipping process of clipping an image in the same region as the clipping region set in the region setting process from each of the images before the composite image is produced by the composite image production process and storing the clipped images in the memory.

According to a sixth aspect of the present invention, there is provided an image processing method for use in a computer equipped with a memory that stores a plurality of images, the method comprising: extracting moving points in an image on the basis of each image stored in the memory; calculating an approximate curve corresponding to the moving points extracted by the moving point extraction; determining whether there is any object on the approximate curve in the images stored in the memory; and when the object determination has determined that there is an object, setting a clipping region that includes the moving points extracted by the moving point extraction and the object and, when the object determination has determined that there is no object, setting a clipping region that includes the moving points extracted by the moving point extraction.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows an external configuration of an image processing and analysis system according to an embodiment of an image processing apparatus of the invention;

FIG. 2 is a block diagram showing a configuration of the electronic circuits of a PC 10 and a graph function electronic calculator 20 of the image processing and analysis system;

FIG. 3 is a flowchart to explain the overall flow of an analysis image producing process performed by the PC 10 of the image processing and analysis system;

FIG. 4 is a flowchart to explain the process (SA) of grouping a plurality of images accompanying the analysis image producing process performed by the PC 10;

FIG. 5 shows a grouped image identification screen P1 displayed on a color display unit 16 as a result of the process (SA) of grouping a plurality of images;

FIG. 6 is a flowchart to explain a plural images→composite image production process (SC) accompanying the analysis image producing process performed by the PC 10;

FIG. 7 shows a plural images→image composition screen P2 displayed on the color display unit 16 as a result of the plural images→composite image production process (SC);

FIG. 8 is a flowchart to explain a clipping region detection process (SE) accompanying the analysis image producing process performed by the PC 10;

FIGS. 9A, 9B, 9C, and 9D show image display actions as a result of the clipping region detection process (SE) and the contents of image processing;

FIG. 10 is a flowchart to explain a moving point trajectory analysis process performed by the graph function electronic calculator 20 of the image processing and analysis system;

FIGS. 11A, 11B, 11C, and 11D show display actions of a color liquid-crystal display unit 25 as a result of a moving point trajectory analysis process for a single image performed by the graph function electronic calculator 20; and

FIGS. 12A, 12B, 12C, and 12D show display actions of the color liquid-crystal display unit 25 as a result of a moving point trajectory analysis process for plural images performed by the graph function electronic calculator 20.

### DETAILED DESCRIPTION OF THE INVENTION

Hereinafter, referring to the accompanying drawings, an embodiment of the invention will be explained.

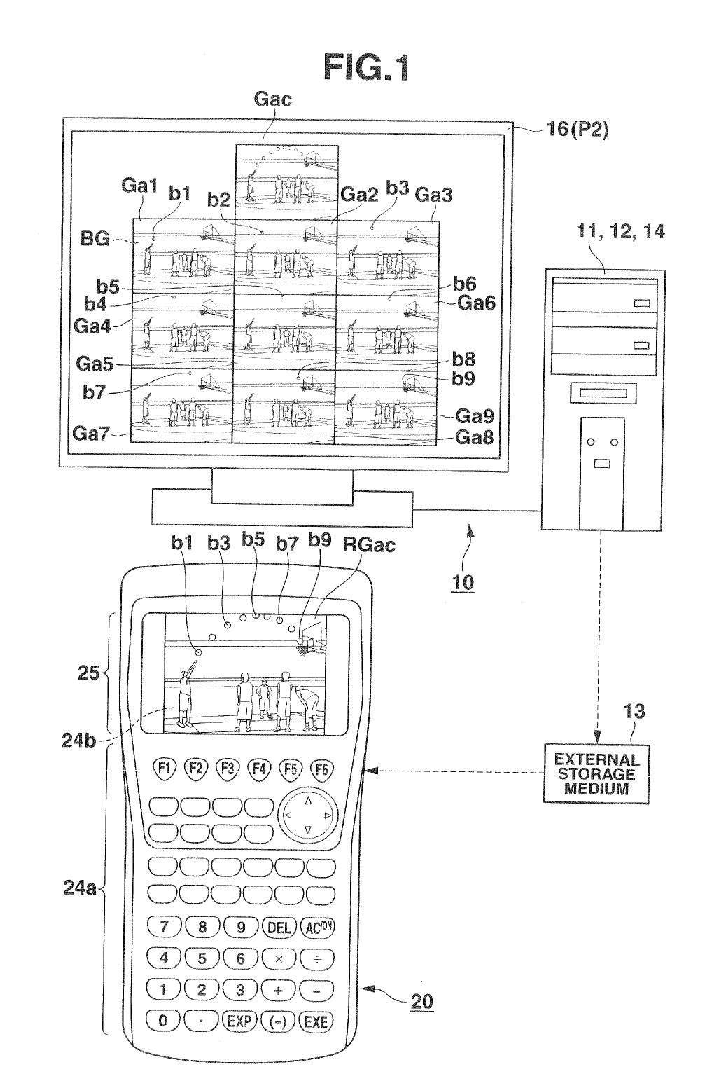

FIG. 1 shows an external configuration of en image processing and analysis system according to an embodiment of an image processing apparatus of the invention.

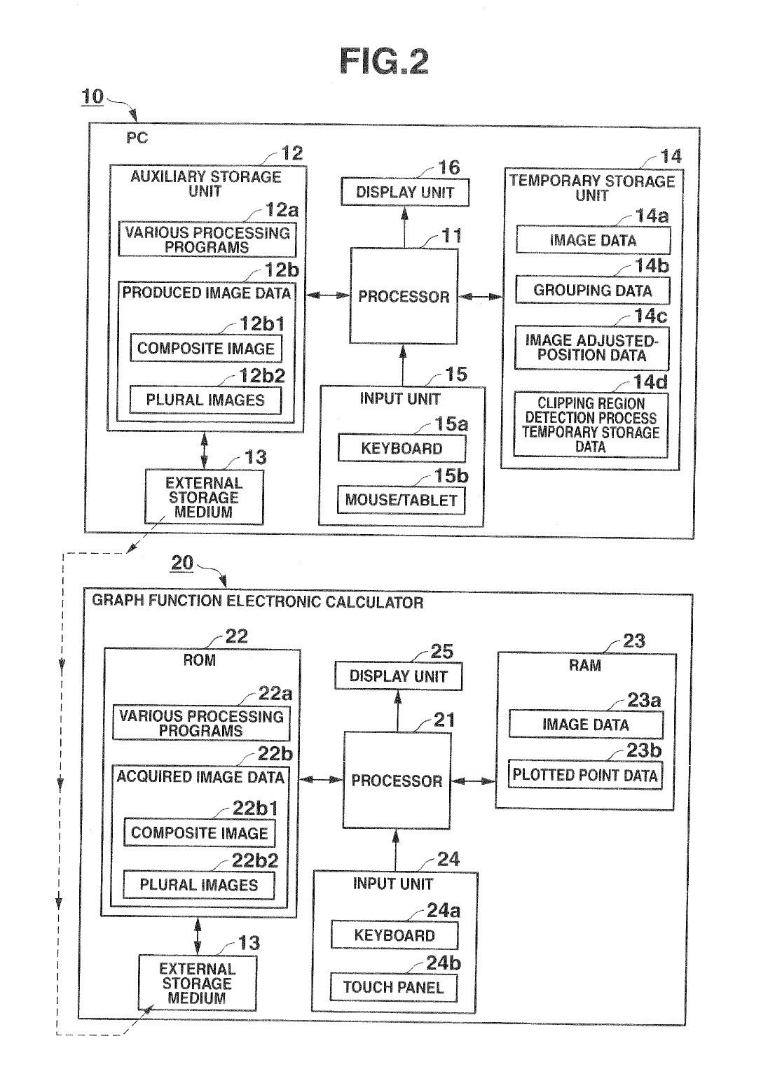

FIG. 2 is a block diagram showing a configuration of the electronic circuits of a PC 10 and a graph function electronic calculator 20 of the image processing and analysis system.

The image processing and analysis system is a combination of a personal computer (PC) 10 that functions as an image processing apparatus and a graph function electronic calculator 20 that functions as an image analysis apparatus.

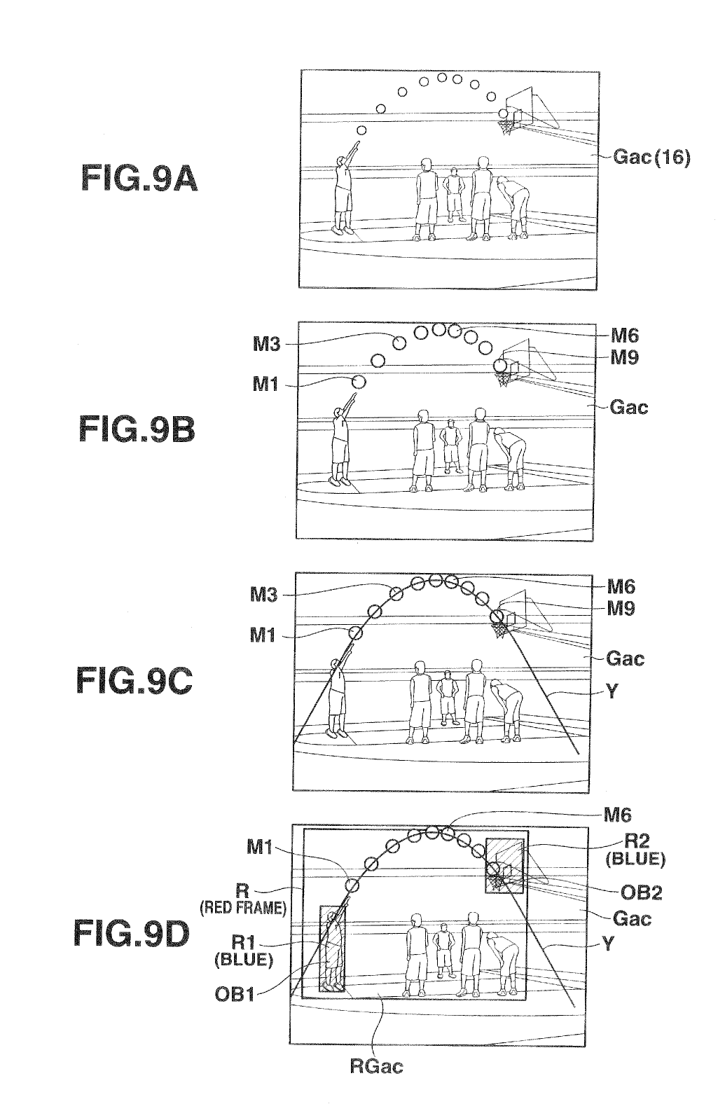

In the image processing and analysis system, the PC 10 has at least the function of acquiring consecutive images (Ga1 to Ga9) shot by a digital camera or the like, the function of producing a composite image (Gac) obtained by superimposing moving point images (b1 to b9) extracted from the consecutive images (Ga1 to Ga9) on a background image (GB), and the function of producing an analysis object image (RGac) (FIG. 9D) obtained by clipping an analysis object region (R) from the composite image (Gac).

The graph function electronic calculator 20 has at least the function of acquiring an analysis object image (RGac) produced by the PC 10 by use of an external storage medium 13 or the like and the function of analyzing the analysis object image (RGac) and displaying the analysis result.

The PC 10 includes a processor (CPU) 11 functioning as a computer.

The processor (CPU) 11 controls the operations of various parts of a circuit using a temporary storage unit 14, such as a RAM, as a working memory according to a PC control program previously stored in an auxiliary storage unit 12, such as an HDD, a PC control program read from an external storage medium 13, such as a memory card, into the auxiliary storage unit 12, or a PC control program downloaded from a Web server (program server) on a communication network into the auxiliary storage unit 12.

The PC control program stored in the auxiliary storage unit 12 is activated according to an input signal resulting from a user operation on an input unit 15.

Not only the auxiliary storage unit 12, temporary storage unit 14, and input unit 15 but also a color display unit 16 is connected to the processor (CPU) 11.

Stored in the auxiliary storage unit 12 are various processing programs 12a, including a PC control program that supervises the overall operation of the PC 10, an application program for performing various processes according to user operations, and an image processing program for performing the process of producing an analysis object image (RGac) on the basis of consecutive images (Ga1 to Ga9).

In the auxiliary storage unit 12, a produced image data storage region 12b is secured. In the produced image data storage region 12b, a composite image storage region 12b1 and a plural image storage region 12b2 are secured.

Stored in the composite image storage region 12b1 is an analysis object image (RGac) of a composite image clipped from a composite image (Gac) obtained by aligning and combining a plurality of images, such as the consecutive images (Ga1 to Ga9), specifying an analysis object region (R).

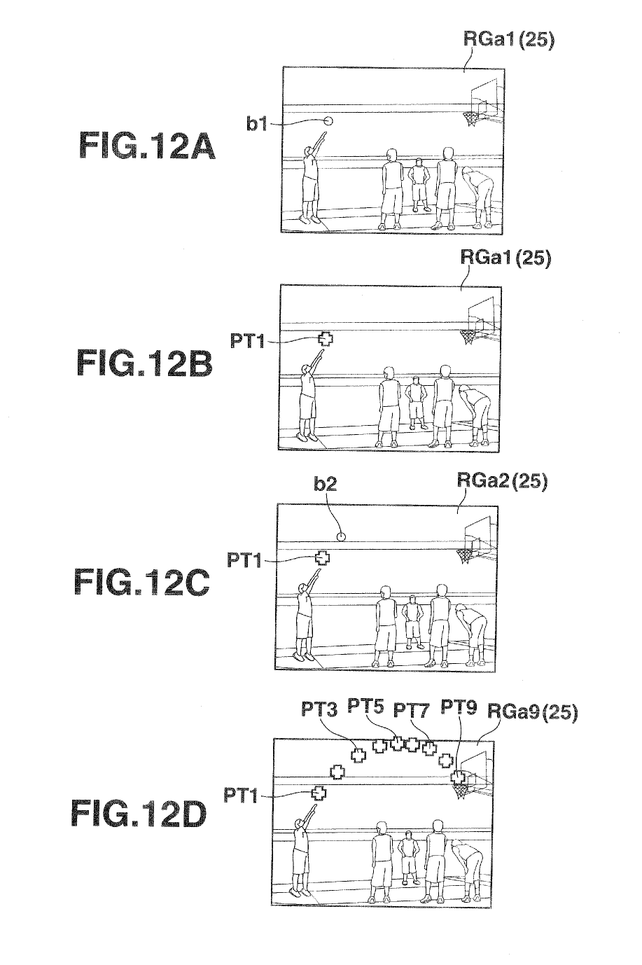

Stored in the plural image storage region 12b2 are a plurality of analysis object images (RGa1 to RGa9) (FIGS. 12A, 12B, 12C, and 12D) obtained by clipping the analysis object region (R) specified for the composite image (Gac) from the aligned images (Ga1 to Ga9).

An image data storage region 14a, a grouping data storage region 14h, an image adjusted-position data storage region 14c, a clipping region detection data storage region 14d, and the like are secured in the temporary storage unit 14.

Various items of image data, such as the consecutive images (Ga1 to Ga9) to be processed by the image processing program, are acquired in communication with an external device or from the external storage medium 13 and stored in the image data storage region 14a.

Identification data for grouping various items of image data stored in the image data storage region 14a according to image type is stored in the grouping data storage region 14b so as to correspond to each of the various items of image data.

Stored in the image adjusted-position data storage region 14c is adjusted-position data obtained by adjusting the position of each of the images two-dimensionally or three-dimensionally when individual items of image data about the same type of consecutive images (Ga1 to Ga9) arbitrarily selected by the user on the basis of the grouping identification data are aligned.

Various items of working data necessary for the process of manually or automatically detecting an analysis object region (R) from an composite image (Gac) obtained by aligning the consecutive images (Ga1 to Ga9) and combining them are stored temporarily in the clipping region detection data storage region 14d.

The input unit 15 is provided with an input device, such as a keyboard 15a or a mouse/tablet 15b, as in an ordinary PC.

The analysis object image (RGac) of the composite image stored in the composite image storage region 12b1 of the produced image data storage region 12b and the analysis object images (RGa1 to RGa9) (FIGS. 12A, 12B, 12C, and 12D) stored in the plural image storage region 12b2 can be stored in an external storage medium 13, such as a USB memory, and read into the graph function electronic calculator 20.

The graph function electronic calculator 20 includes a processor (CPU) 21 functioning as a computer.

The processor (CPU) 21 controls the operations of various parts of a circuit using a RAM 23 as a working memory according to an electronic calculator control program previously stored in a ROM 22, an electronic calculator control program read from an external storage medium 13, such as a memory card, into the ROM 22, or an electronic calculator control program downloaded from a Web server (program server) on a communication network into the ROM 22.

The electronic calculator control program stored in the ROM 22 is activated according to an input signal resulting from a user operation on an input unit 24.

Not only the ROM 22, RAM 23, and input unit 24 but also a dot-matrix color liquid-crystal display unit 25 is connected to the processor (CPU) 21.

Stored in the ROM 22 are various processing programs 22a, including an electronic calculator control program that supervises the overall operation of the graph function electronic calculator 20, an arithmetic processing program for performing various arithmetic calculations according to user operations, and an image analysis program for analyzing analysis object images (RGac) (RGa1 to RGa9 [FIGS. 12A, 12B, 12C, and 12D]) produced by the PC 20 and displaying the analysis result.

In the ROM 22, an acquired image data storage region 22b is secured. Secured in the acquired image data storage region 22b are a composite image storage region 22b1 for storing an analysis object image (RGac) of a composite image read from the PC 10 by use of the external storage medium 13 and a plural image storage region 22b2 for storing a plurality of analysis object images (RGa1 to RGa9) (FIGS. 12A, 12B, 12C, and 12D) read by use of the external storage medium 13.

An image data storage region 23a, a plotted point data storage region 23b, and the like are secured in the RAM 23.

Image data to be processed by the image analysis program is read from the composite image storage region 22b1 or plural image storage region 22b2 of the acquired image data storage region 22b and stored in the image data storage region 23a.

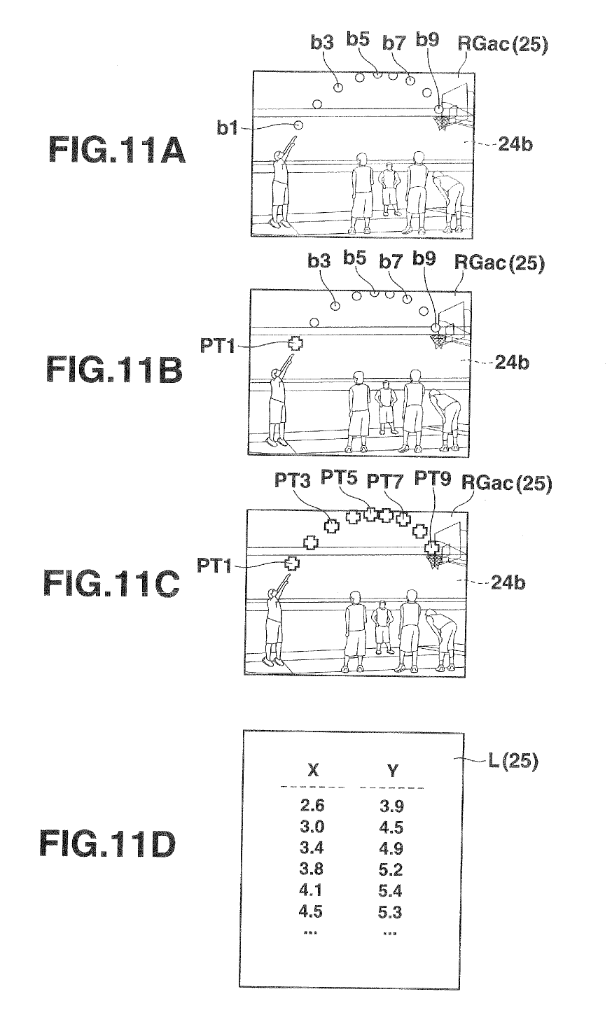

Stored in the plotted point data storage region 23b is coordinate data on plotted points (PT1 to PT9) obtained by plotting moving points (b1 to b9) included in the analysis object image (RGac) of the composite image as shown in, for example, FIGS. 11A, 11B, 11C, and 11D or coordinate data on plotted points (PT1 to PT9) obtained by sequentially plotting moving points (b1 to b9) included in each of the analysis object images (RGa1 to RGa9) as shown in, for example, FIGS. 12A, 12B, 12C, and 12D when an image analysis process is performed according to the image analysis program.

The input unit 24 includes a keyboard 24a that includes alphanumeric and kana character input keys, various function and symbol input keys, various function switching and setting keys, execution key, and cursor keys and a touch panel 24b which is composed of a transparent tablet that is laid on the color liquid-crystal display unit 25 and configured to detect coordinate data corresponding to the position touched by the user on the display screen.

Next, the operation of the image processing and analysis system configured as described above will be explained.

(Analysis Image Producing Function of PC 10)

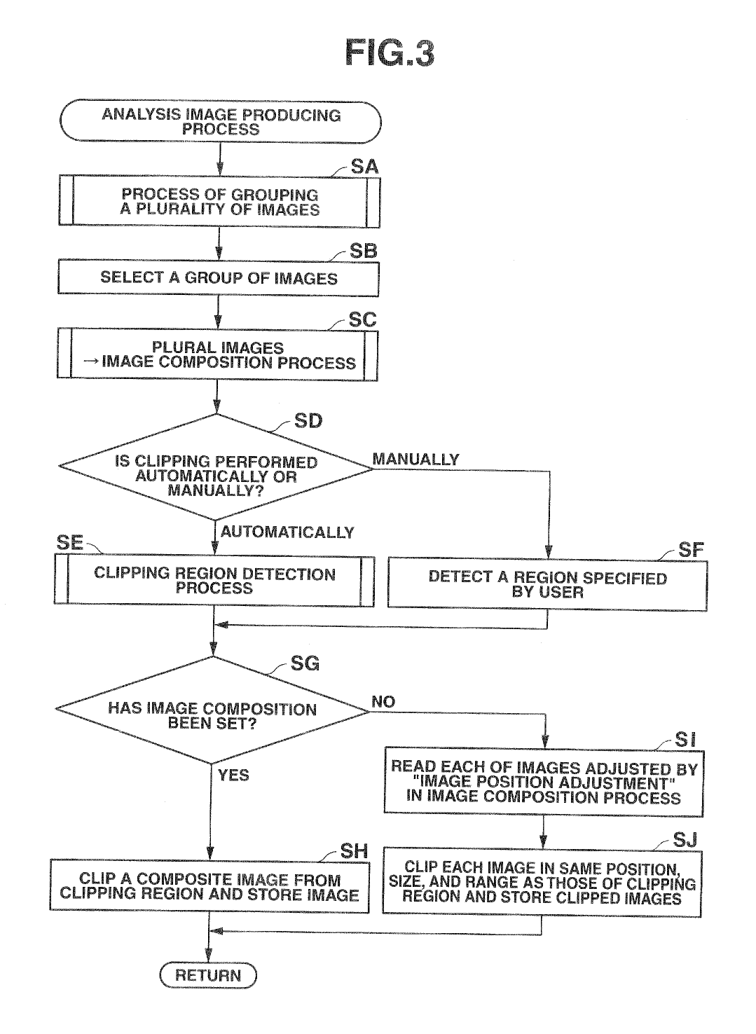

FIG. 3 is a flowchart to explain the overall flow of an analysis image producing process performed by the PC 10 of the image processing and analysis system.

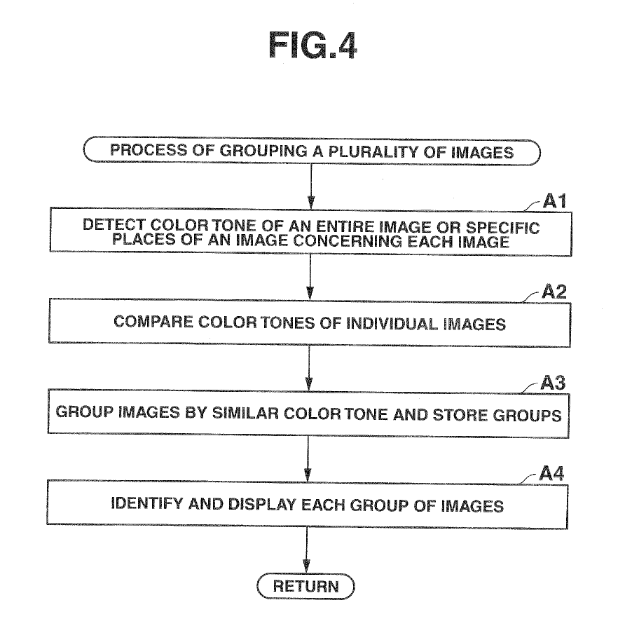

FIG. 4 is a flowchart to explain the process (SA) of grouping a plurality of images accompanying the analysis image producing process performed by the PC 10.

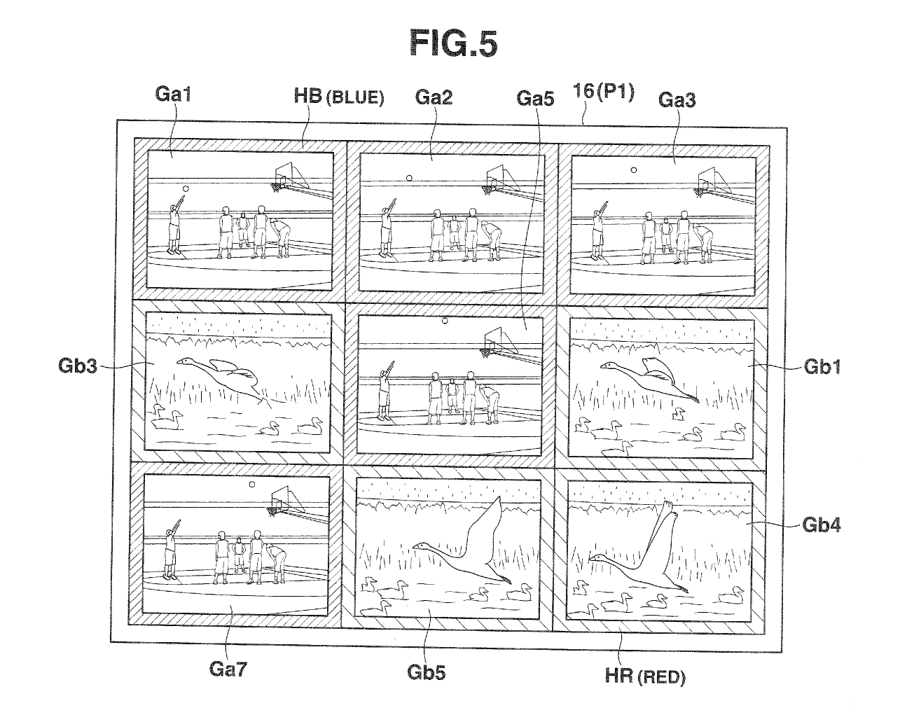

FIG. 5 shows a grouped image identification screen P1 displayed on the color display unit 16 as a result of the process (SA) of grouping a plurality of images.

When the image processing program is activated, the process (SA) of grouping a plurality of images in FIG. 4 is started and the color tone of an entire image or a specific part of an image is detected concerning each of images Ga1, Ga2, . . . , Gb1, Gb2, . . . stored in the image data storage region 14a of the temporary storage unit 14 (step A1).

Then, the color tones of images Ga1, Ga2, . . . , Gb1, Gb2, . . . are compared with one another so as to determine the proximity of them (step A2). The proximity of color tone can be determined using well-known techniques. For example, the proximity of color tone can be determined by calculating the similarities of two color images as disclosed in patent document: Jpn. Pat. Appln. KOKAI Publication No. 2009-86762.

Then, images are grouped according to the degree of similarity of color tone and items of identification data corresponding to the grouping are stored in the grouping data storage region 14b so as to correspond to images Ga1, Ga2, . . . , Gb1, Gb2, . . . in the image data storage region 14a (step A3). When the technique disclosed in, for example, patent document: Jpn. Pat, Appln. KOKAI Publication No. 2009-86762 is used to group images according to the degree of similarity of color tone, the degree of similarity of arbitrary two ones of the images is calculated. If the degree of similarity is not less than a specific value, they are sorted into the same group. If the degree of similarity is less than the specific value, they are sorted into another group.

Then, as shown in FIG. 5, an identification screen P1 is displayed on the color display unit 16 (step A4). On the identification screen P1, a group of consecutive images Ga1, Ga2, . . . obtained by photographing a shot at the basket is subjected to identification display HB in blue and, at the same time, a group of consecutive images Gb1, Gb2, . . . obtained by photographing a flying bird is subjected to identification display HR in red as shown in, for example, FIG. 5 according to the items of grouping identification data corresponding to images Ga1, Ga2, . . . , Gb1, Gb2, . . . stored in the grouping data storage region 14b.

On the identification screen P1 for the grouped images, when a group of images to be analyzed according to a user operation is selected (step SB), the plural images→composite image production process is performed on each of the images in the selected group (Ga1, Ga2, . . . or Gb1, Gb2, . . . ) (step SC).

Here, a case where consecutive images Ga1, Ga2, . . . of basketball subjected to identification display HB in blue on the identification screen P1 have been selected will be explained.

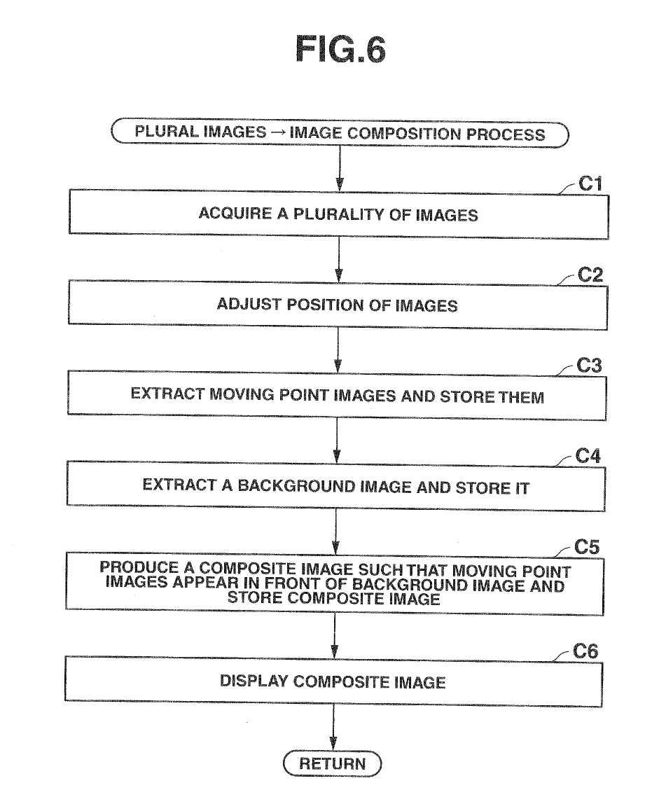

FIG. 6 is a flowchart to explain a plural images→composite image production process (SC) accompanying the analysis image producing process performed by the PC 10.

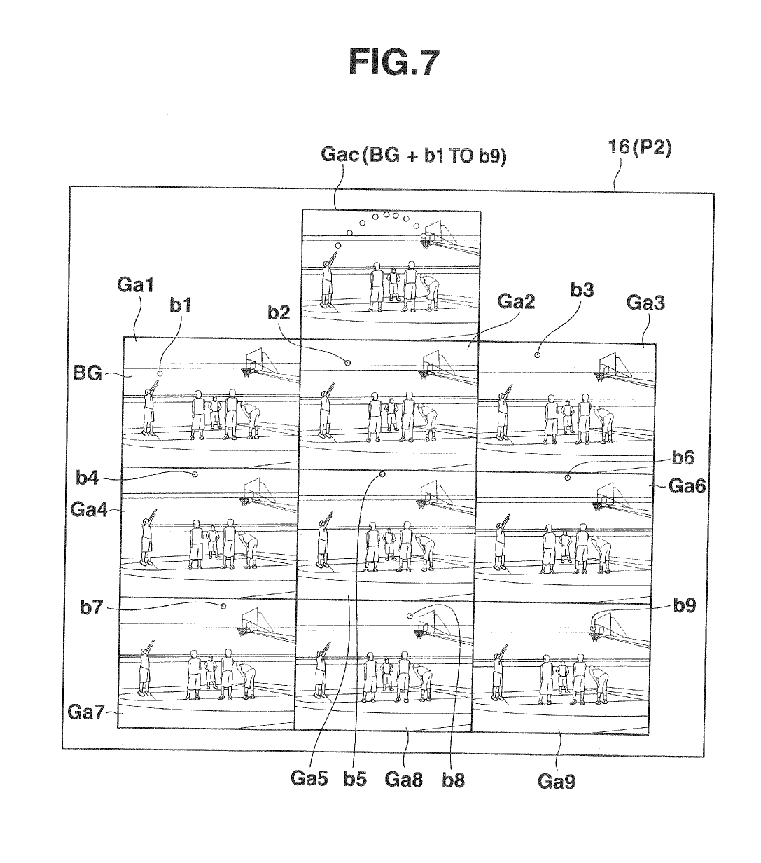

FIG. 7 shows a plural images→image composition screen P2 displayed on the color display unit 16 accompanying the plural images→composite image production process (SC).

When the plural images→composite image production process (SC) is started, the consecutive images Ga1 to Ga9 of a basketball selected by the user from the image data storage region 14a of the temporary storage unit 4 are acquired and displayed in array in the lower part of the plural images→image composition screen P2 (step C1).

Then, a plurality of fixed image parts (e.g., two or three places of the corners of the goalpost) which are the same between images are detected concerning the consecutive images Ga1 to Ga9 and the position of each of the images is adjusted two-dimensionally or three-dimensionally such that the images Ga1 to Ga9 are aligned using the detected image parts as reference points. Then, adjusted-position data on the images Ga1 to Ga9 is stored in the image adjusted-position data storage region 14c (step C2).

Next, moving point images (balls) b1 to b9 are extracted from the images Ga1 to Ga9 by a difference detection method or a motion vector detection method between the images Ga1 to Ga9 and are stored together with position data on the moving point images b1 to b9 in the images Ga1 to Ga9 into the temporary storage unit 14 (step C3).

A part not extracted as moving point image b1 from one (e.g., Ga1) of the images Ga1 to Ga9 is extracted as a background image BG and stored in the temporary storage unit 14 (step C4).

Then, each of the moving point images b1 to b9 extracted and stored in step C3 is superimposed on the background image BG extracted and stored in step C4, thereby producing a composite image Gac, which is stored in the temporary storage unit 14 (step C5).

Then, the composite image Gac produced and stored in step C5 is displayed in the upper part of the plural images→image composition screen P2 as shown in FIG. 7 (step C6).

In this way, whether a region to be analyzed is clipped automatically or manually from the composite image Gac produced by the plural image→composite image production process (step SC) is set according to a user operation (step SD).

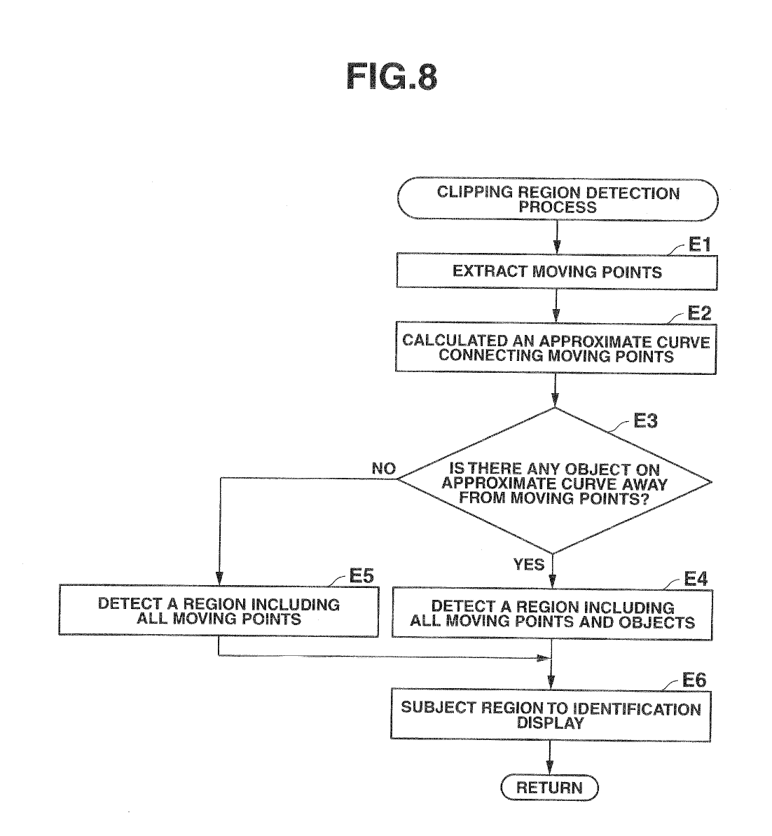

Here, if it has been determined that “automatically” has been set (step SD [automatically]), a clipping region detection process in FIG. 8 is performed (step SE).

FIG. 8 is a flowchart to explain a clipping region detection process (SE) accompanying the analysis image producing process performed by the PC 10.

FIGS. 9A, 9B, 9C, and 9D show image display actions as a result of the clipping region detection process (SE) and the contents of image processing.

When the clipping region detection process (SE) is started, the composite image Gac produced and stored according to the plural images→composite image production process (SC) is displayed on the color display unit 16 as shown in FIG. 9A.

Then, as shown in FIG. 9B where an internal process is visualized, items of position data M1 to M9 on moving point images b1 to b9 stored in step C3 of the plural images→composite image production process (SC) are extracted (step E1) and an approximate curve Y connecting positions M1 to M9 of the moving points on the composite image Gac is calculated as shown in FIG. 9C (step E2).

At this time, the calculated approximate curve Y is limited to, for example, simple types of curves in the range taught in school (such as a quadratic curve [Y=ax²+b], a cubic curve [Y=ax³+bx²+c], a trigonometric function curve [Y=sin x] [Y=cos x], a logarithmic function curve [Y=log x], or a hyperbolic curve). Other complicated types of curves are not calculated as the approximate curve Y.

Then, whether there is an object, such as a body, a person, or an animal, is determined by image analysis on the approximate curve Y away from positions M1 to M9 of the moving points in the composite image Gac (step E3).

Here, as shown in FIG. 9D, if it has been determined that there are objects OB1, OB2 of persons or bodies on the approximate curve Y away from positions M1 to M9 of the moving points in the composite image Gac (step E3 [Yes]), a rectangular region enclosing the objects OB1, OB2 is subjected to identification displays R1, R2 in blue and a rectangular region (R) including positions M1 to M9 of all the moving points and the regions (R1, R2) of objects OB1, OB2 is detected (step E4).

Then, the rectangular region (R) including positions M1 to 09 of all the moving points and the regions (R1, R2) of objects OB1, OB2 detected in the composite image Gac is identified as a clipping region for an analysis object image RGac by a red frame R (step. E6).

If it has been determined that there is no object on the approximate curve Y away from positions M1 to M9 of the moving points in the composite image Gac (step E3 [No]), a rectangular region (R) including positions M1 to M9 of all the moving points is detected (step E5).

Then, the rectangular region (R) including positions M1 to M9 of all the moving points detected in the composite image Gac is identified as a clipping region for an analysis object image RGac by a red frame R (step E6).

A clipping region for the detected analysis object image RGac may be identified by the red frame R without identification display of moving point extracting positions M1 to M9 in FIG. 9D, display of the approximate curve Y, or blue identification display Rn of the rectangular region enclosing objects OBn.

In step SD, if it has been determined that “manually” has been set (step SD [manually]), a region specified according to a user operation is detected from the composite image Gac displayed on the display unit 16 and a clipping region for the detected analysis object image RGac is identified by the red frame R (step SF).

When the clipping region (R) of the analysis object image RGac in the composite image Gac has been detected (step SD→SE [SF]), whether the analysis object image is obtained as a composite image or as the individual, images before the image composition is determined by the setting according to a user operation (step SG).

Here, if it has been determined that the analysis object images are obtained as a composite image (step SG [Yes]), a region detected in step SE or SF and indentified by the red frame is clipped from the composite image Gac and is stored as an analysis object image RGac of the composite image in the composite image storage region 12b1 of the produced image data storage region 12b (step SH).

If it has been determined that the analysis object images are obtained as the individual images before the image composition (step SG [No]), images Ga1 to Ga9 aligned by an image position adjustment process (C2) accompanying the composite image production process (SC) are read (step SI).

Then, a region which has the same position, size, and range as those of the region detected in step SE or SF and identified by the red frame R is clipped from the aligned images Ga1 to Ga9. The clipped regions are stored as a plurality of analysis object images (RGa1 to RGa9 (FIGS. 12A, 12B, 12C, and 12D) in the plural image storage region 12b2 of the produced image data storage region 12b (step SJ).

The analysis object image (RGac) of the composite image produced in the composite image product ion process by the PC 10 and stored in the composite image storage region 12b1 of the produced image data storage region 12b and the analysis object images (RGa1 to RGa9) (FIGS. 12A, 12B, 12C, and 12D) stored in the plural image storage region 12b2 are stored in an external storage medium 13, such as a USB memory, and analyzed with the graph function electronic calculator 20.

Accordingly, with the analysis image producing function of the PC 10 configured as described above, consecutive images (Ga1 to Ga9) are aligned and moving point images (b1 to b9) extracted from the aligned consecutive images (Ga1 to Ga9) are superimposed on a background image (GB), thereby producing a composite image (Gac). When a rectangular region including, for example, the moving point images (b1 to b9) is specified as an analysis object region (R) for the composite image (Gac), an analysis object image (RGac) of a composite image clipped from the specified region (R) is produced. A rectangular region which has the same position, size, and range as those of the region (R) specified for the composite image (Sac) is clipped from the aligned images (Ga1 to Ga9), thereby producing a plurality of analysis object images (RGa1 to RGa9).

Therefore, when a region in the same position including the corresponding one of the moving points (b1 to b9) is clipped as an analysis object image (RGa1 to RGa9) from each of the consecutive images (Ga1 to Ga9), the images (Ga1 to Ga9) can be clipped en bloc without the trouble of specifying and clipping the images (Ga1 to Ga9) one by one.

Furthermore, with the analysis image producing function of the PC 10 configured as described above, the analysis object region (R) specified for the composite image (Gac) is detected as a rectangular region including all the moving point images (b1 to b9) on the basis of items of position data (M1 to M9) on the moving point images (b1 to b9) when the region (R) is specified automatically. Alternatively, an approximate curve Y connecting items of position data (M1 to M9) on the moving point images (b1 to b9) is calculated and the analysis object region (R) is detected as a rectangular region including all the moving point images (b1 to b9) and objects existing on the approximate curve Y.

Therefore, for example, a region (R) to be analyzed in a moving point trajectory can be detected easily in an accurate range and an analysis object image (RGac) of the composite image or a plurality of analysis object images (RGa1 to RGa9) can be produced.

(Moving Point Trajectory Analysis Function of Graph Function. Electronic Calculator 20)

First, an analysis object image (RGac) of an composite image produced in the analysis image producing process by the PC 10 or a plurality of analysis object images (RGa1 to RGa9) are acquired from the external storage medium 13 and stored in the acquired image data storage region 22b of the graph function electronic calculator 20.

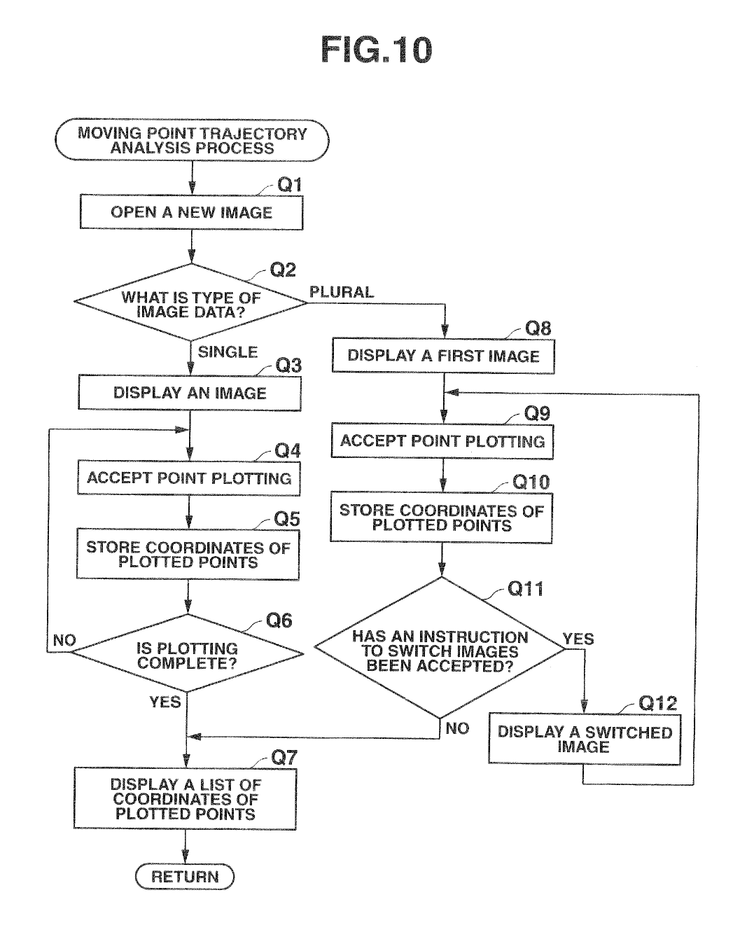

FIG. 10 is a flowchart to explain a moving point trajectory analysis process performed by the graph function electronic calculator 20 of the image processing and analysis system.

When the moving point trajectory analysis process is activated, new image data stored in the acquired image data storage region 22b is read (step Q1).

Then, it is determined whether the type of the new image data read from the acquired image data storage region 22b is a single image or plural images, that is, whether the type of the new image data is the analysis object image (RGac) of the composite image read from the composite image storage region 22b1 or the analysis object images (RGa1 to RGa9) read from the plural image storage region 22b2 (step Q2).

FIGS. 11A, 11B, 11C, and 11D show display actions of the color liquid-crystal display unit 25 as a result of the moving point trajectory analysis process for a single image performed by the graph function electronic calculator 20.

If the new image data read from the acquired image data storage region 22b is the analysis object image RGac of the composite image read from the composite image storage region 22b1 and is a single image (step Q2 (single), the analysis object image RGac of the composite image is displayed on the color liquid-crystal display unit 25 provided with the touch panel 24b as shown in FIG. 11A (step Q3).

When the positions of moving point images b1 to b9 to be analyzed on the image RGac are plotted sequentially according to a user touch operation on the analysis object image RGac of the composite image as shown in FIGS. 11B and 11C, the coordinates of the plotted points PT1 to PT9 are stored sequentially in the plotted point data storage region 23b (steps Q4 to Q6).

Then, the coordinates of plotted points PT1 to PT9 corresponding to the moving point images b1 to b9 stored in the plotted point data storage region 23b are displayed as a moving point analysis coordinate list L on the color liquid-crystal display unit 25 as shown in FIG. 11D (step Q7).

This enables the moving point trajectory to be analyzed immediately from the analysis object image RGac of the composite image acquired from the PC 10 and displayed on the color liquid-crystal display unit 25 and to be displayed and studied without performing any special image processing.

FIGS. 12A, 12B, 12C, and 12D show display actions of the color liquid-crystal display unit 25 as a result of the moving point trajectory analysis process for plural images performed by the graph function electronic calculator 20.

If it has been determined that the new image data read from the acquired image data storage region 22b is the analysis object images RGa1 to RGa9 read from the plural image storage region 22b2 and is plural images (step Q2 [plural]), the first one RGa1 of the analysis object images RGa1 to RGa9 is displayed on the color liquid-crystal display unit 25 provided with the touch panel 24b (step Q8).

When the position of moving point image b1 on the image RGa1 is plotted on the displayed first analysis object image RGa1 according to a user touch operation as shown in FIG. 12B (step Q9), the coordinates of the plotted point PT1 are stored in the plotted point data storage region 23b (step Q10).

Here, if it has been determined that an instruction to switch images according to a user operation has been given (step Q11 [Yes]), the second analysis object image RGa2 is displayed on the color liquid-crystal display unit 25 in place of the first one, while the plotted point PT1 of the first one remains displayed (step Q12).

Thereafter, as shown in FIGS. 12C and 12D, the moving point images b2 to b9 are plotted each time the analysis object image is switched to the next one sequentially from the second to ninth analysis object images RGa2 to RGa9, with the result that the coordinates of the corresponding plotted points PT2 to PT9 are additionally stored in the plotted point data storage region 23b (steps Q9 to Q12).

Then, the coordinates of the plotted points PT1 to PT9 corresponding to the moving point images b1 to b9 of each of the analysis object images RGa1 to RGa9 stored in the plotted point data storage region 23b are displayed as a moving point analysis coordinate list L on the color liquid-crystal display unit 25 (step Q7).

This enables the moving point trajectory to be analyzed immediately from the analysis object images RGa1 to RGa9 acquired from the PC 10 and displayed one after another by switching on the color liquid-crystal display unit 25 and to be displayed and studied without performing any special image processing.

The methods of performing the analysis image producing process with the PC 10 described in the embodiment, including the analysis image producing process shown in the flowchart of FIG. 3, the process of grouping a plurality of images shown in the flowchart of FIG. 4 accompanying the analysis image producing process, the plural images→composite image production process shown in the flowchart of FIG. 6, and the clipping region detection process shown in the flowchart, of FIG. 8, can be stored in an external storage medium (13), such as a memory card (e.g., a ROM or PAM card), a magnetic disk (e.g., d floppy disk or hard disk), an optical disk (e.g., a CD-ROM or DVD), or a semiconductor memory, in the form of programs the computer can execute. Then, the external storage mediums can be delivered. The computer (11) of the PC 10 reads the program stored in the external storage medium (13) into a storage unit (12). The computer is controlled by the read-in program, thereby realizing the analysis image producing function on the basis of consecutive images (Ga1 to Ga9) explained in the embodiment, which enables the same processes in the aforementioned methods to be carried out.

Furthermore, the data of the programs which realize the above methods can be transferred in the form of program code over a communication network (public line). The program data can be loaded by a communication device connected to the communication network into the computer (11) of the PC 10, thereby realizing the analysis image producing function on the basis of the consecutive images (Ga1 to Ga9).

This invention is not limited to the above embodiments and, on the basis of available skills in the present or future implementation phase, may be practiced or embodied in still other ways without departing from the spirit or character thereof. Furthermore, the embodiments include inventions of different stages and therefore various inventions can be extracted by combining suitably a plurality of component elements disclosed in the embodiments. For example, if some component elements are removed from all of the component elements shown in the embodiments or some component elements are combined suitably in a different mode, the resulting configuration can be extracted as an invention, provided that the subject to be achieved by the invention is accomplished and the effect of the invention is obtained.

For example, equations of a curve for calculating an approximate curve may be stored in the auxiliary storage unit 12 in advance and an approximate curve in step E2 may be calculated by selecting the most suitable one from the previously stored curves.

Furthermore, a plurality of analysis object images (RGa1 to RGa9) stored in step SJ may be saved in separate files image by image or all saved in a single file. When a plurality of images are saved in separate files image by image, whether a single image or plural images have been saved can be determined in step Q2 by, for example, determining that a single image has been saved if one file has been opened in step Q1 and that plural images have been saved if plural files have been opened in step Q1. In addition, when plurality of images are all saved in a single file, whether a single image or plural images have been saved can be determined in step Q2 by, for example, adding an extension different from that of a file composed of a single image when a file composed of a plurality of images is created and comparing the extensions.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing apparatus comprising:
a display unit;
a memory that stores a plurality of images; and
a processor that performs:
a composite image production process of producing a composite image composed of a plurality of images stored in the memory,
a composite image display process of displaying the produced composite image on the display unit,
a region setting process of setting a clipping region on the displayed composite image, and
an image clipping process of clipping an image in the same region as the set clipping region from each of the images before the composite image is produced and storing the clipped images in a memory.

2. The image processing apparatus according to claim 1, wherein the composite image production process includes an image position adjustment process of aligning the images stored in the memory with one another, and
the processor further performs a process of producing a composite image composed of the images aligned by the image position adjustment process.

3. The image processing apparatus according to claim 1, wherein the processor further performs:
a plural image grouping process of grouping a plurality of images stored in the memory by image type,
an image group identification display process of identifying the grouped images by image type and displaying them on the display unit,
an image group selection process of selecting an arbitrary group of images according to a user operation, wherein the composite image production process includes an image acquisition process of acquiring an image group selected by the image group selection process, and
a process of producing a composite image composed of the image group acquired by the image acquisition process.

4. The image processing apparatus according to claim 1, wherein the region setting process includes:
a moving point extraction process of extracting moving points in a composite image produced by the composite image production process on the basis of the images before the composite image is produced by the composite image production process,
an approximate curve calculation process of calculating an approximate curve corresponding to the moving points extracted by the moving point extraction process, and
an object determination process of determining whether there is any object on the approximate curve in the composite image produced by the composite image production process, and
wherein the processor further performs a process of, when the object determination process has determined that there is an object, setting a clipping region that includes the moving points extracted by the moving point extraction process and the object and, when the object determining process has determined that there is no object, setting a clipping region that includes the moving points extracted by the moving point extraction process.

5. An image processing apparatus comprising:
a memory that stores a plurality of images; and
a processor that performs:
a moving point extraction process of extracting moving points in an image on the basis of each image stored in the memory,
an approximate curve calculation process of calculating an approximate curve corresponding to the moving points extracted by the moving point extraction process,
an object determination process of determining whether there is any object on the approximate curve in the images stored in the memory, and
a region setting process of, when the object determination process has determined that there is an object, setting a clipping region that includes the moving points extracted by the moving point extraction process and the object and, when the object determination process has determined that there is no object, setting a clipping region that includes the moving points extracted by the moving point extraction process.

6. A computer-readable medium that stores a program including a series of instructions executed by a computer system equipped with a display unit and a memory that stores a plurality of images, the program causing the computer system to perform:
a composite image production process of producing a composite image composed of a plurality of images stored in the memory,
a composite image display process of displaying the produced composite image on the display unit,
a region setting process of setting a clipping region on the displayed composite image, and
an image clipping process of clipping an image in the same region as the clipping region set by the region setting process from each of the images before the composite image is produced and storing the clipped images in a memory.

7. The computer-readable medium according to claim 6, wherein the composite image production process includes an image position adjustment process of aligning the images stored in the memory with one another, and
the program further causes the computer system to perform a process of producing a composite image composed of the images aligned by the image position adjustment process.

8. The computer-readable medium according to claim 6, wherein the program further causes the computer system to perform:
a plural image grouping process of grouping a plurality of images stored in the memory by image type,
an image group identification display process of identifying the grouped images by image type and displaying them on the display unit,
an image group selection process of selecting an arbitrary group of images according to a user operation, wherein the composite image production process includes an image acquisition process of acquiring an image group selected by the image group selection process, and
a process of producing a composite image composed of the image group acquired by the image acquisition process.

9. The computer-readable medium according to claim 6, wherein the region setting process includes:
a moving point extraction process of extracting moving points in a composite image produced by the composite image production process on the basis of the images before the composite image is produced by the composite image production process,
an approximate curve calculation process of calculating an approximate curve corresponding to the moving points extracted by the moving point extraction process, and
an object determination process of determining whether there is any object on the approximate curve in the composite image produced by the composite image production process, and
wherein the program further causes the computer system to perform a process of, when the object determination process has determined that there is an object, setting a clipping region that includes the moving points extracted by the moving point extraction process and the object and, when the object determining process has determined that there is no object, setting a clipping region that includes the moving points extracted by the moving point extraction process.

10. A computer-readable medium that stores a program including a series of instructions executed by a computer system equipped with a memory that stores a plurality of images, the program causing the computer system to perform:
a moving point extraction process of extracting moving points in an image on the basis of each image stored in the memory;
an approximate curve calculation process of calculating an approximate curve corresponding to the moving points extracted by the moving point extraction process;
an object determination process of determining whether there is any object on the approximate curve in the images stored in the memory; and
a region setting process of, when the object determination process has determined that there is an object, setting a clipping region that includes the moving points extracted by the moving point extraction process and the object and, when the object determination process has determined that there is no object, setting a clipping region that includes the moving points extracted by the moving point extraction process.

11. An image processing method for use in a computer equipped with a display unit and a memory that stores a plurality of images, the method comprising:
executing a composite image production process of producing a composite image composed of a plurality of images stored in the memory;
executing a composite image display process of displaying the composite image produced by the composite image production process on the display unit;
executing a region setting process of setting a clipping region on the composite image displayed in the composite image display process; and
executing an image clipping process of clipping an image in the same region as the clipping region set in the region setting process from each of the images before the composite image is produced by the composite image production process and storing the clipped images in the memory.

12. The image processing method according to claim 11, wherein the composite image production process includes an image position adjustment process of aligning the images stored in the memory with one another, and
the method further comprises executing a process of producing a composite image composed of the images aligned by the image position adjustment process.

13. The image processing method according to claim 11, further comprising:
executing a plural image grouping process of grouping a plurality of images stored in the memory by image type,
executing an image group identification display process of identifying the grouped images by image type and displaying them on the display unit,
executing an image group selection process of selecting an arbitrary group of images according to a user operation, wherein the composite image production process includes an image acquisition process of acquiring an image group selected by the image group selection process, and
executing a process of producing a composite image composed of the image group acquired by the image acquisition process.

14. The image processing method according to claim 11, wherein the region setting process includes:
a moving point extraction process of extracting moving points in a composite image produced by the composite image production process on the basis of the images before the composite image is produced by the composite image production process,
an approximate curve calculation process of calculating an approximate curve corresponding to the moving points extracted by the moving point extraction process, and
an object determination process of determining whether there is any object on the approximate curve in the composite image produced by the composite image production process, and
wherein the method further comprises executing a process of, when the object determination process has determined that there is an object, setting a clipping region that includes the moving points extracted by the moving point extraction process and the object and, when the object determining process has determined that there is no object, setting a clipping region that includes the moving points extracted by the moving point extraction process.

15. An image processing method for use in a computer equipped with a memory that stores a plurality of images, the method comprising:
extracting moving points in an image on the basis of each image stored in the memory;
calculating an approximate curve corresponding to the moving points extracted by the moving point extraction;
determining whether there is any object on the approximate curve in the images stored in the memory; and
when the object determination has determined that there is an object, setting a clipping region that includes the moving points extracted by the moving point extraction and the object and, when the object determination has determined that there is no object, setting a clipping region that includes the moving points extracted by the moving point extraction.
